(19) United States
(12) Patent Application Publication
(10) Pub. No.: US 2009/0223971 A1
(43) Pub. Date: Sep. 10, 2009

(54) ORGANIZER FOR ACCESSORY ITEMS

(76) Inventor: Brian Moffett, Littleton, CO (US)

Correspondence Address: HOLLAND & HART, LLP, P.O BOX 8749, DENVER, CO, 80201, US

(21) Appl. No.: 12/398,573

(22) Filed: Mar. 5, 2009

Related U.S. Application Data
(60) Provisional application No. 61/033,988, filed on Mar. 5, 2008.

(51) Int. Cl. B65D 25/04; B65D 25/28; E05C 3/12

(52) U.S. Cl. 220/500; 16/114.1; 292/194

(57) ABSTRACT

An organizer for storing accessories including a case which includes a first storage region, a second storage region and a partition panel disposed there between. The first and second storage regions are, respectively, provided with a modular array of first and second compartments. The storage regions are movable with respect to one another between a case closed position and a case open position. The partition panel is selectively movable when the case is open to either prevent access to a selected one of the storage regions or to permit access to each of the storage regions.

### BACKGROUND

There are many benefits to being organized. For instance, an organized desk is more aesthetic and makes it easier for a worker to focus on the task at hand. Being organized may also reduce stress as it promotes efficiency and a sense of control. Organization comes in many forms such as time management, organizing documents and computer files to name a few. Of interest in this case, however, is the organization of collections of items, components, and accessories. When items are organized they are easier to find when needed, thus promoting efficiency and reducing frustration. Also, it is easier to determine when items are missing or need replacing if they are stored in an organized fashion.

There exist many situations where people engage in activities such as crafts, trades, and hobbies where a multitude of components, accessories, or items are utilized. For example, fishing is an activity requiring various lures, hooks, swivels, sinkers, bobbers, and flies to name just a few. Another example of a situation where multiple components are utilized is the electrical or low voltage trades. An electrician may require various sockets, connectors, conduit components, wall plates, electrical boxes, and fasteners in order to construct an electrical system.

There has always been a need to organize and categorize these types of items. In the past, people have used organizer bins and drawer systems to contain items in an organized fashion. For situations where these components need to be transported outdoors or to a worksite, portable boxes with organizing trays have been employed. One example of such a situation is fishing. In this case it is well known to use what is termed a tackle box. A tackle box can be roughly the size of a shoebox and contains various trays with small preconfigured compartments for stowing tackle, such as lures, hooks, swivels, and sinkers.

An example of a situation where items need to be transported to a worksite is where an electrician transports components used in the trade to and from various worksites. A tackle box-type organizer is quite suitable for fishing gear; however, it is less conducive to managing larger components such as those needed by an electrician. In the past the electrician might simply combine all of the needed components in a duffel bag for example. Such a practice, however, provides no means of organizing and displaying the various components such that they are readily available for installation. Although existing organizers and tackle boxes are suitable for their intended purpose there are other situations where a more adaptable and convenient means of storing, transporting, organizing, and displaying components is needed.

There are many instances where, coincident with the need for an organizer, is the need for a suitable work surface. It is often the case where an electrician is installing an electrical system on a worksite and where a fisherman is outdoors, that there are few flat working surfaces available. Also, in the case of an electrician or other tradesmen the job may cover a large work area in which a portable work surface would be a benefit. As such, there is a need for an improved organizer which also provides an integral portable work surface.

### SUMMARY

An organizer for storing accessories is disclosed. According to one exemplary embodiment the organizer comprises a case which includes a first storage region, a second storage region and a partition panel disposed there between. The first and second storage regions are, respectively, provided with a modular array of first and second compartments. The storage regions are movable with respect to one another between a case closed position and a case open position. The partition panel is selectively movable when the case is open to either prevent access to a selected one of the storage regions or to permit access to each of the storage regions.

Preferably, the modular arrays of first and second compartments include a plurality of differently sized compartments to accommodate accessories of differing characteristics. To this end each of the compartments includes a plurality of row partitions provided with slide ways. The dividers are removably disposed in the slide ways between adjacent row partitions. Each of the first and second storage regions includes an associated bottom wall, and these walls are oriented in a common plane when the case is in a fully deployed position (i.e., fully open) such that the partition panel may selectively cover one of the first and second storage regions to provide a working surface. When the first and second storage regions are moved into a partially deployed position, in which they are oriented at an angle with respect to one another, the partition panel may selectively cover the first storage region to prevent spillage of its contents.

Preferably, a handle is disposed on the partition panel to allow the case to be conveniently transported. At least one latch releasably secures the partition panel to either or both of the first and second storage regions. Where a plurality of latches are employed, at least a first latch may reasonably secure the partition panel to the first storage region and at least a second latch may releasably of the secure the partition panel to the second storage region. In an alternative construction, a latch mechanism selectively attaches the partition to one of the first and second storage regions while concurrently detaching it from the other region.

According to another embodiment, an accessory item organizer comprises first and second compartments which are removably joined between an organizer open position and an organizer closed position. A substantially rigid partition panel is provided with a handle and disposed between the compartment arrays. A latch mechanism selectively attaches the partition panel to one of the first and second arrays while concurrently detaching it from another of the arrays.

In yet another embodiment, an accessory item organizer comprises a partition panel having a double-walled construction. The partition panel comprising a first wall panel and a second wall panel that are separable from one another. The first and second wall panels are releasably attached to one another with a latch structure, preferably via a snap-fit engagement. Preferably also, the first and second wall panels are constructed identically.

The first and second wall panels are operative, when the organizer is in a fully deployed position, to move away from one another to selectively cover said first and second regions, respectively. The organizer may include first and second pairs of cooperative fastening elements associated with the first and second wall panels and their corresponding storage regions to allow the wall panels to releasably cover the compartments while providing a working surface.

### BRIEF DESCRIPTION OF THE DRAWINGS

FIG. 1 is a perspective view illustrating an organizer according to a first exemplary embodiment that is shown in a fully deployed (i.e., case open) position;

FIG. 2 is a partial perspective view of the organizer shown in FIG. 1 illustrating the modular assembly of one of its storage regions;

FIG. 3 is a top plan view of the organizer shown in FIG. 1 with compartments configured to accommodate a representative collection of items;

FIG. 4 is a bottom plan view of the organizer shown in FIG. 1;

FIG. 5 is a side view in elevation of the organizer shown in FIG. 1, arranged in a stowed (i.e., case closed) configuration;

FIG. 6 is a side view in elevation of the organizer shown in FIG. 1, arranged in a partially deployed configuration;

FIG. 7 is a side view in elevation of the organizer shown in FIG. 1, arranged in the fully deployed configuration;

FIG. 8 is a perspective view illustrating an organizer according to a second exemplary embodiment that is shown in a fully deployed configuration;

FIG. 9 is a side view in elevation of the organizer shown in FIG. 8;

FIG. 10 is an enlarged perspective view illustrating an organizer according to a third exemplary embodiment;

FIG. 11A is a perspective view of the organizer shown in FIG. 10, arranged with the storage regions released from each other;

FIG. 11B is a perspective view of the organizer shown in FIG. 10, arranged with the storage regions released from each other and one of the wall panels opened;

FIG. 11C is a perspective view of the organizer shown in FIG. 10, arranged with the storage regions released from each other and both wall panels opened;

FIG. 12 is an enlarged partial perspective view of the partition latches shown in FIG. 10;

FIG. 13 is a partial cross-sectional view of the partition latches shown in FIG. 12 as taken about line 13-13;

FIG. 14 is partial cross-sectional view of the box latches shown in FIG. 10 as viewed about line 14-14;

FIG. 15 is partial cross-sectional view of the lid latches shown in FIG. 10 as viewed about line 15-15;

FIG. 16 is a front view in elevation of the organizer shown in FIG. 10;

FIG. 17 is a cross-sectional view of the organizer as viewed about line 17-17 as shown in FIG. 16;

FIG. 18 is an enlarged cross sectional view of a hinge clip; and

FIG. 19 is an enlarged partial perspective view of the hinge clip shown in FIGS. 17 and 18 attached to one of the storage regions.

### DETAILED DESCRIPTION OF THE EXEMPLARY EMBODIMENTS

Provided herein is an accessory item organizer in the form of a case. In preferred embodiments, the organizer includes an integral work surface. The organizer is configurable to accommodate a variety of differently sized and shaped items. The organizer disclosed is a more adaptable and convenient means of storing, transporting, organizing, and displaying items.

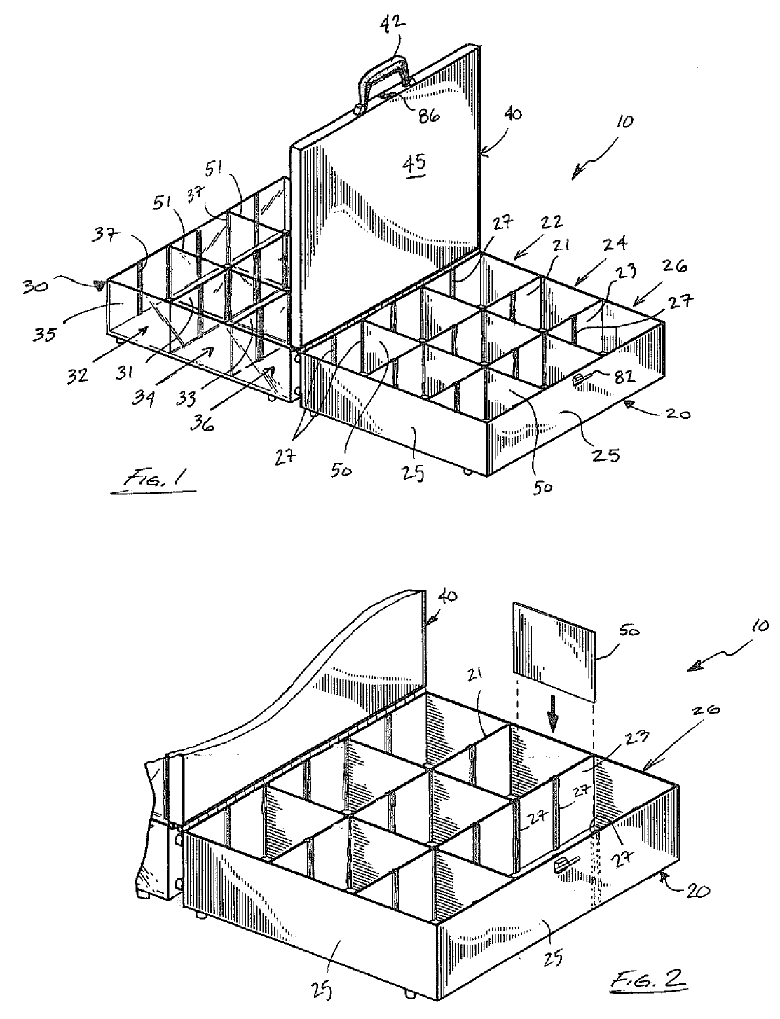

FIG. 1 illustrates a first exemplary embodiment of the accessory item organizer 10 in a fully deployed configuration. Organizer 10 includes a first storage region 20 and a second storage region 30. Each storage region includes a modular array of compartments. As will be described more fully below, a partition panel 40 is movably disposed between storage regions or compartment arrays 20 and 30. Compartment arrays 20 and 30 are rotatably attached to partition panel 40 with hinges 70 and 72. As shown in this embodiment the hinges illustrated are of the type commonly referred to as piano hinges. This arrangement allows each compartment to be accessed independently of the other.

Compartment array 20 includes surrounding sidewall 25 and bottom wall or panel 29 (see FIG. 4). Compartment array 20 also includes one or more integrally formed row partitions, such as row partitions 21 and 23. Partitions 21 and 23 define rows 22, 24, and 26. Each row partition preferably includes a plurality of slideways 27. The slideways are sized and adapted to receive removable dividers 50. As is perhaps best shown in FIG. 2, removable dividers 50 may be inserted at various locations along row partitions 21 and 23 in order to create compartments of different sizes, thus providing a modular construction. It should be understood that the configuration shown in FIG. 1 is merely an example and various combinations of rows and columns are contemplated. Moreover, row partitions 21 and 23 may be oriented perpendicular to the orientation shown in the figures.

Second compartment array 30 has a similar construction as compartment array 20 with row partitions 31 and 33 defining rows 32, 34, and 36. Again, each row partition includes slideways 37 for receiving removable dividers 51. In this embodiment compartment array 20 is formed of an opaque material, whereas compartment array 30 is formed of a transparent material thereby allowing identification of items stored therein. Alternatively, the entire organizer could either be opaque or transparent. Preferably, the compartment arrays 20 and 30 are formed of a plastic material. However it should be appreciated that the compartment arrays may be formed of any suitable material or combination of materials such as plastic, sheet-metal, and wood.

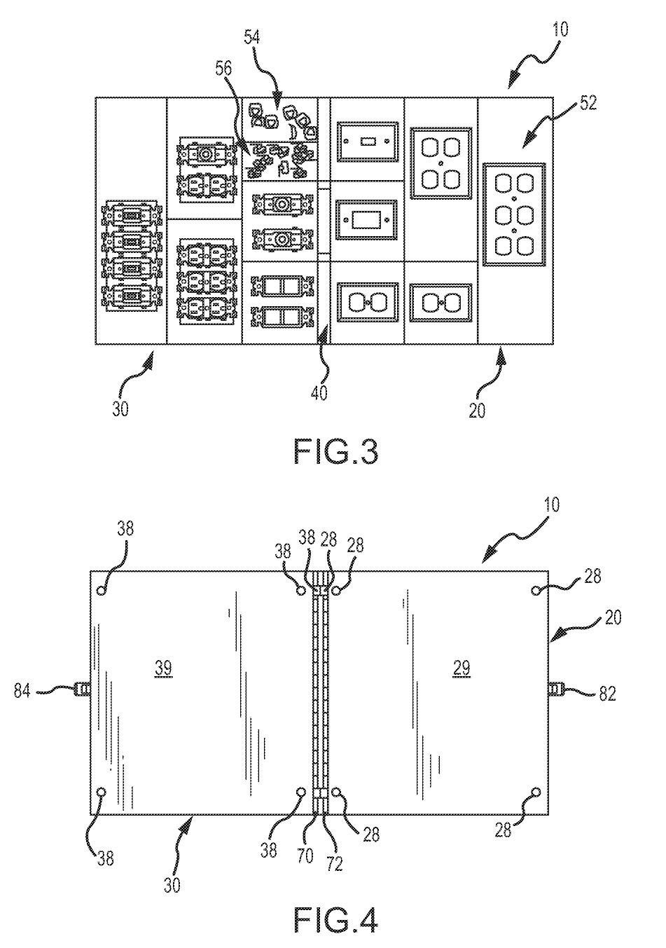

FIG. 3 is a top view illustration of organizer 10 that has been configured to accommodate various sized electrical components. For example, compartment 52 is a large compartment which consists of a single row with no removable dividers 50 installed. Also shown are small component compartments 54 and 56. Although electrical components are shown here for example, one skilled in the art will appreciate that the compartment arrays may be configured to receive various other items, accessories, or components as desired.

FIG. 4 is an illustration showing organizer 10 as viewed from below. Bottom panels 29 and 39 of compartment arrays 20 and 30 respectively include support feet 28 and 38 respectively. Also, support feet may be disposed on the surrounding sidewalls of the two compartments. The support feet support the organizer thereby helping to prevent scratches to the organizer case. This is particularly important where, as is shown in FIG. 1, the compartment array is formed of a transparent material.

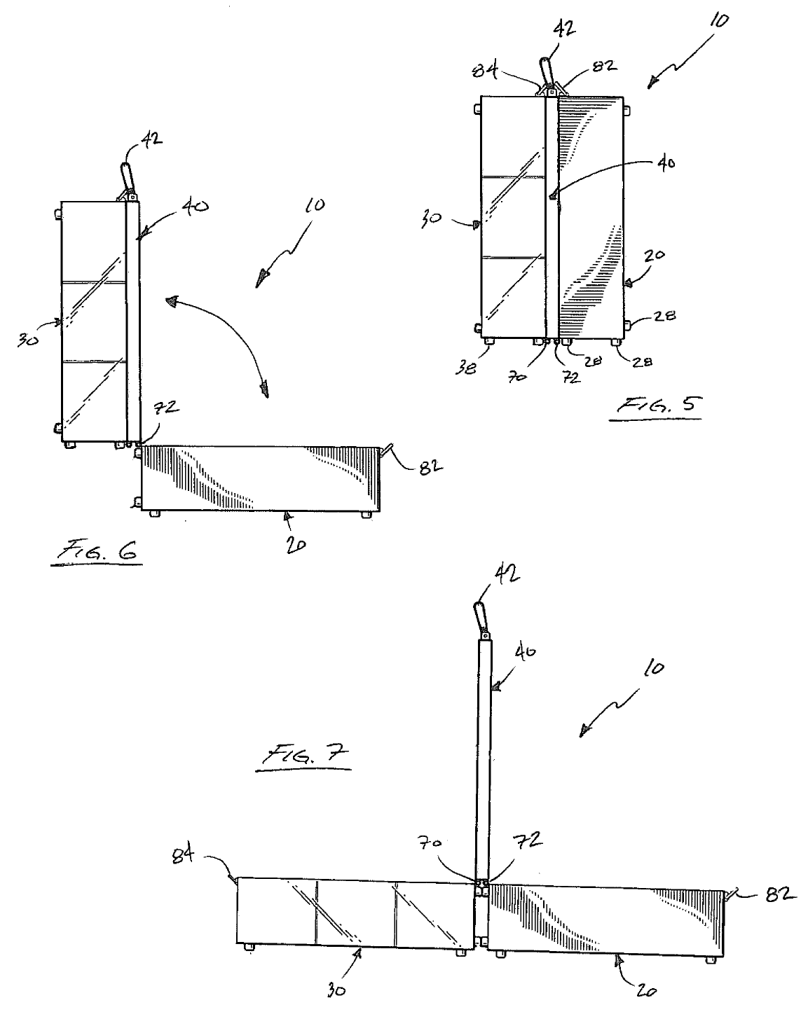

As is shown in FIG. 5 the organizer takes the form of a case. In this figure the organizer is shown in its fully stowed configuration. Partition panel 40 acts as a lid for compartment arrays 20 and 30. When in a closed or stowed position latches 82 and 84 secure the compartment arrays to the partition panel 40. Partition panel 40 also includes a handle 42 providing a convenient means of carrying the organizer 10. FIG. 6 illustrates the organizer in a partially deployed state. In this case latch 82 has been disengaged allowing partition panel 40 along with second compartment array 30 to rotate away from compartment array 20 about hinge 72. FIG. 7 is a side view of the organizer in a fully deployed state. In this case latch 84 has also been released allowing partition panel 40 to rotate away from second compartment array 30 about hinge 74. In this configuration both sides of the organizer case are accessible.

FIGS. 8 and 9 illustrate a second exemplary embodiment of the organizer case. The compartment arrays of organizer 210 are similar to organizer 10 but in this embodiment a single hinge 270 joins the first and second compartment arrays 220 and 230, respectively. As perhaps best shown in FIG. 8, hinge 270 is comprised of a plurality of barrel portions integrally formed into compartment array 220, compartment array 230 and divider panel 240. Divider panel 240 includes barrel portions 274, which are integrally formed with the divider panel 240. Similarly, compartment array 220 includes barrel portions 276 integrally formed thereon. Likewise, compartment array 230 includes barrel portions 278 which are preferably integrally formed on compartment array 230. Each of these barrel portions interlock with each other and rotate about hinge pin 272. As can be seen in FIGS. 8 and 9 organizer case 210 provides a work surface 245 which is conveniently located next to compartment array 220.

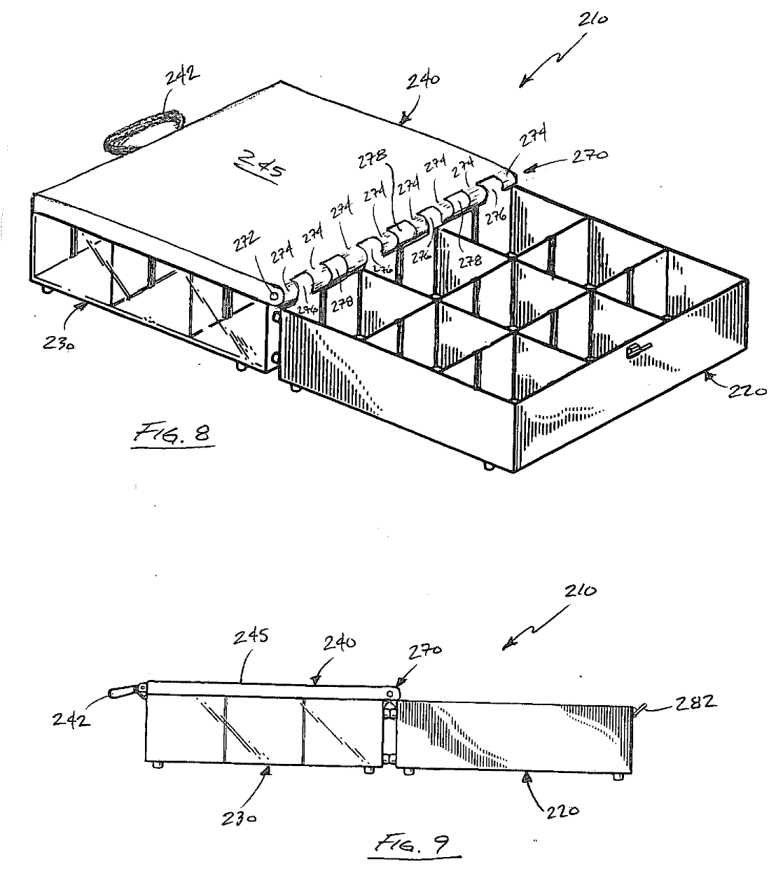

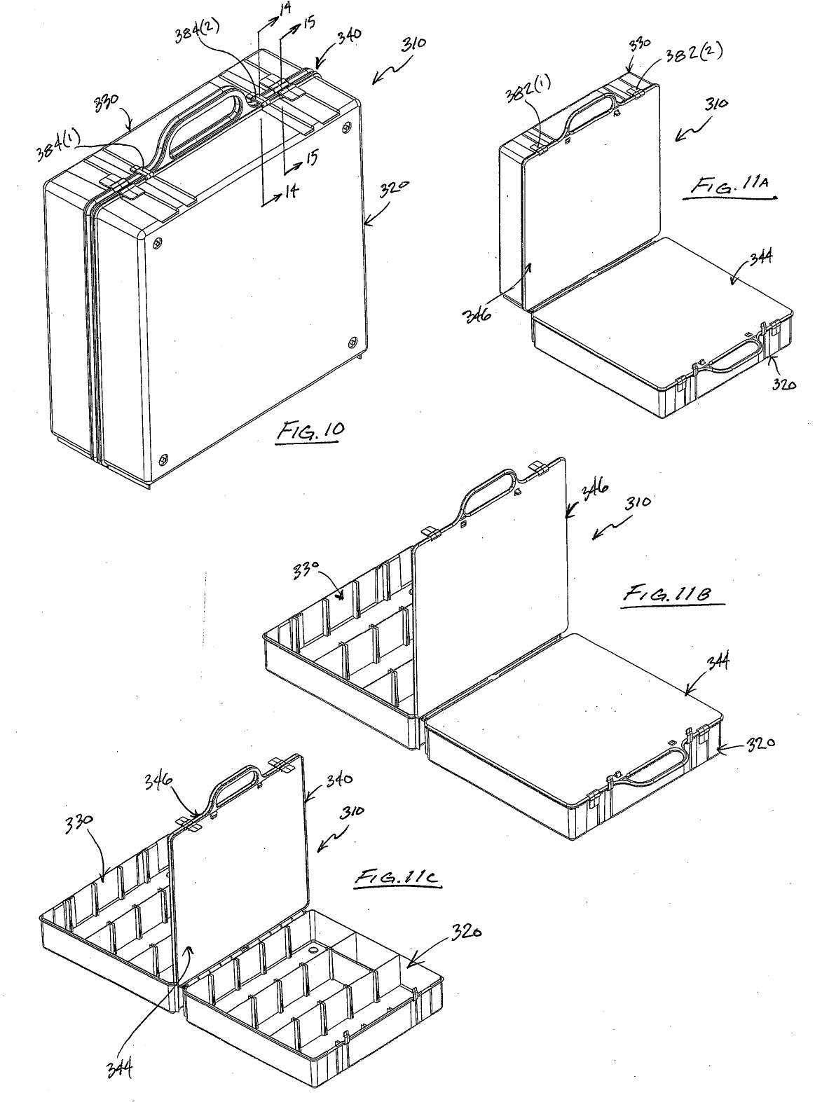

A third exemplary embodiment of the accessory item organizer 310 is introduced in FIG. 10. Organizer 310 includes a first storage region 320 and a second storage region 330. Each storage region includes a modular array of compartments similar to those described above with respect to the first and second embodiments. Organizer 310 includes partition panel 340 disposed between storage regions, or compartment arrays, 320 and 330. Compartment arrays 320 and 330 are rotatably attached to partition panel 340 with hinges. Referring to FIGS. 11A-11C it should be noted that partition panel 340 has a double-walled construction that includes separable wall panels or partition lids 344 and 346. Each wall panel is associated with a respective compartment array. Accordingly, each compartment array may be selectively accessed as desired. Organizer 310 includes box latches 384(1) and 384(2). Each partition lid includes a fastener 382(1) and 382(2) as shown in, for example, FIG. 11A. The details of the box latches and lid fasteners are described more fully below.

FIGS. 11A-11C illustrate the various configurations that organizer 310 may assume. For instance, FIG. 11A illustrates that organizer 310 is configurable such that both wall panels 344 and 346 are closed. As an example, this configuration may be advantageous for providing a work surface comprised of both wall panels 344 and 346. As shown in FIG. 11B, each wall panel may be opened as desired. In this case, wall panel 346 is opened, thereby providing access to compartment array 330 while compartment array 320 remains closed. Finally, in FIG. 11C both compartment arrays 320 and 330 are open and wall panels 344 and 346 are releasably attached to one another as a single partition 340. In the fully deployed position shown in FIG. 11C the bottom walls of the compartment arrays 320 and 330 are oriented in a common plane.

Referring now to FIGS. 12 and 13, wall panel latch mechanisms 380(1) and 380(2) are described more fully. It should be appreciated at this point that wall panels 344 in 346 have the same construction such that they may be formed in the same mold yet function as lids for opposite compartment arrays. Similarly, compartment arrays 320 and 330 have the same construction, again, so that they may be formed from a single mold. Wall panel latch mechanisms 380(1) and 380(2) each include a latch arm or tab 390 which is configured to engage latch pin 392 via a snap-fit engagement. Wall panel latches 380(1) and 380(2) are useful for releasably attaching wall panels 344 and 346 to each other when both compartments 320 and 330 are open.

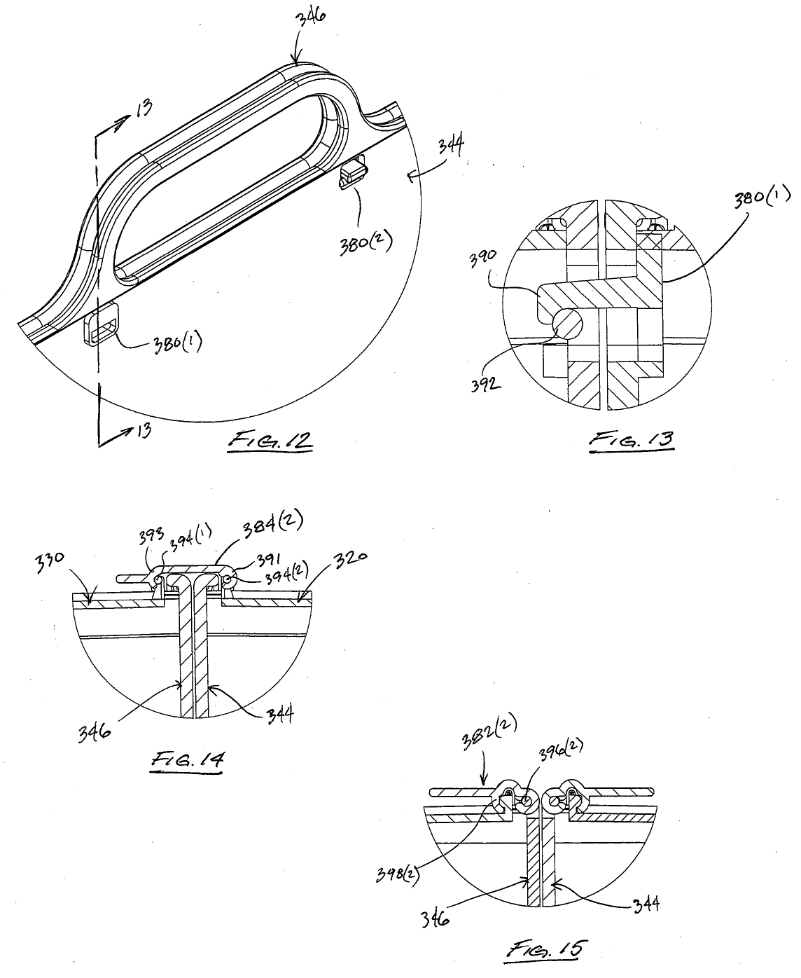

FIG. 14 illustrates box latch 384(2). The box latches 384(1) and 384(2) are used to secure compartment arrays 320 and 330 to each other in a stowed state. In this case box latch 384(2) includes hinge portion 391 and latch portion 393. Hinge portion 391 rotates about pivot pin 394(2) and latch 393 engages latch pin 394(1). Compartment 320 and compartment 330 each include a pin 394, which can function as either a pivot pin or a latch pin as necessary. FIG. 15 illustrates lid fastener 382(2) in some detail. Lid fastener 382(2) rotatably engages pivot pin 396(2). Fastener 382(2) also includes a latch portion 398(2), which cooperatively engages an associated container.

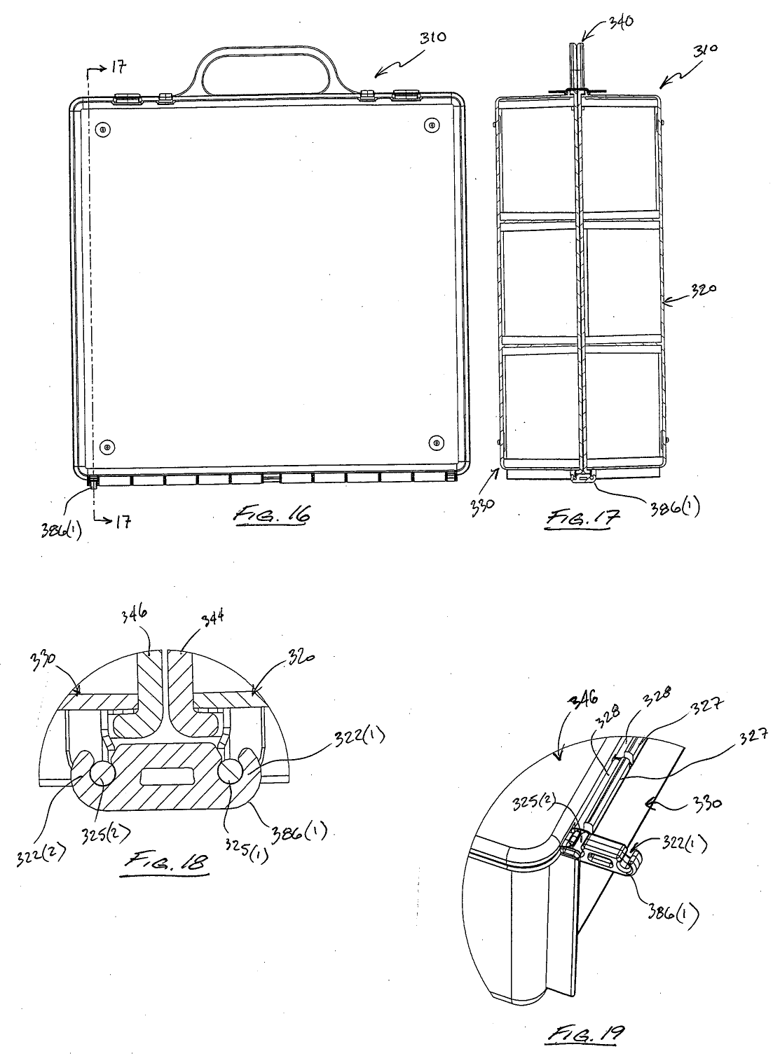

FIG. 16 is a front view of container 310 illustrating the location of hinge clip 386(1). As shown in FIG. 17, hinge clip 386(1) pivotably attaches compartment array 320 to compartment array 330. With further reference to FIGS. 18 and 19 it can be seen that hinge clip 386(1) includes hinge recesses 322(1) and 322(2), which engage hinge pins 325(1) and 325(2). Hinge pins 325 may be integrally molded, as perhaps best shown in FIG. 19, to their respective compartment arrays, in this case compartment array 330. Also shown in FIG. 19, wall panel 346 includes a plurality of hinge recesses 327 that engage hinge pins 328, which are integrally formed with compartment array 330.

Accordingly, the present invention has been described with some degree of particularity directed to the exemplary embodiments. It should be appreciated, though, that the present invention is defined by the following claims construed in light of the prior art so that modifications or changes may be made to the exemplary embodiments without departing from the inventive concepts contained herein.

What is claimed is:

1. An organizer for storing accessories, comprising:
a. a case including:
i. a first storage region provided with a modular array of first compartments;
ii. a second storage region provided with a modular array of second compartments, said first and second storage regions movable with respect to one another between a case closed position and a case open position; and
iii. a partition panel disposed between said first and second storage regions and selectively movable when said case is in the case open position to either prevent access to a selected one of said first and second storage regions or permit access to each of said first and second storage regions.

2. An organizer according to claim 1 further comprising a handle disposed on said partition panel to allow transport when said case is in the closed position.

3. An organizer according to claim 1 including at least one latch for releasably securing said partition panel to said first and second storage regions.

4. An organizer according to claim 1 including a plurality of latches for releasably securing said partition panel to said first and second storage regions;

5. An organizer according to claim 4 wherein at least a first latch releasably secures said partition panel to said first storage region and at least a second latch releasably secures said partition panel to said second storage region.

6. An organizer according to claim 1 including a latch mechanism for selectively attaching said partition to one of said first and second storage regions, while concurrently detaching said partition panel to from another of said first and second storage regions.

7. An organizer according to claim 1 wherein said first storage region includes an associated first bottom wall and said second storage region includes an associated second bottom wall, said first bottom wall oriented in a common plane with said second bottom wall when said case is in a fully deployed position, such that said partition panel may selectively cover one of said first and second storage regions to provide a working surface.

8. An organizer according to claim 7 wherein, as said first and second storage regions are movable into a partially deployed position in which they are oriented at an angle with respect to one another, said partition panel may selectively cover said first storage region to prevent spillage of contents therefrom.

9. An organizer according to claim 1 wherein said modular array of first compartments includes a plurality of differently sized first compartments.

10. An organizer according to claim 1 wherein said modular array of second compartments includes a plurality of differently sized second compartments.

11. An organizer according to claim 1 wherein said modular array of first compartments includes a plurality of row partitions each provided with a plurality of slideways, and a plurality of dividers removably disposed in slideways between adjacent ones of said row partitions.

12. An organizer according to claim 1 wherein said modular array of second compartments includes a plurality of row partitions each provided with a plurality of slideways, and a plurality of dividers removably disposed in slideways between adjacent ones of said row partitions.

13. An organizer according to claim 1 wherein said partition panel has a double-walled construction.

14. An organizer according to claim 1 wherein said partition panel comprising a first wall panel and a second wall panel that are separable from one another.

15. An organizer according to claim 14 wherein said first and second wall panels are releasably attached to one another.

16. An organizer according to claim 15 including a latch structure for releasably attaching said first and second wall panels to one another.

17. An organizer according to claim 15 wherein said first and second wall panels are releasably attached via snap-fit engagement.

18. An organizer according to claim 15 wherein said first and second wall panels are constructed identically.

19. An organizer according to claim 14 wherein said first and second wall panels are operative, when said organizer is in a fully deployed position, to move away from one another to selectively cover said first and second regions, respectively.

20. An organizer according to claim 19 including a first pair of cooperative fastening elements associated with said first wall panel and said first storage region to allow said first wall panel to releasably cover said first compartments while providing a first working surface.

21. An organizer according to claim 20 including a second pair of cooperative fastening elements associated with said second wall panel and said second storage region to allow said first wall panel to releasably cover said second compartments while providing a second working surface.

22. An accessory item organizer, comprising:
a. a first compartment array;
b. a second compartment array movably joined to said first compartment array between an organizer open position and an organizer closed position; and
c. a substantially rigid partition panel disposed between said first and second compartments;
d. a handle disposed on said partition panel; and
e. a latch mechanism for selectively attaching said partition to one of said first and second storage regions, while currently detaching said partition panel from another of said first and second storage regions.
